(19) United States
(12) Patent Application Publication
(10) Pub. No.: US 2006/0162083 A1
(43) Pub. Date: Jul. 27, 2006

(54) BED TRAPEZE LIFT WITH BED CONTROLS, LIGHTS AND PATIENT TRANSFERABILITY

(75) Inventor: Richard H. Heimbrock, Cincinnati, OH (US)

Correspondence Address: BARNES & THORNBURG, 11 SOUTH MERIDIAN, INDIANAPOLIS, IN, 46204, US

(73) Assignee: HILL-ROM SERVICES, INC., Wilmington, DE (US)

(21) Appl. No.: 11/275,683

(22) Filed: Jan. 24, 2006

Related U.S. Application Data
(60) Provisional application No. 60/647,662, filed on Jan. 27, 2005.

(51) Int. Cl. A47C 31/00; A61G 7/14

(52) U.S. Cl. 5/662; 5/81.1 R

(57) ABSTRACT

A trapeze apparatus for use with a patient-support device such as a hospital bed, for example, includes a pivotable coupler formed to define a pivot axis and an arm pivotable about the pivot axis. A patient interface unit of the trapeze apparatus includes a trapeze handle coupled to the arm and patient operated controls coupled to the trapeze handle.

### RELATED APPLICATIONS

This application claims the benefit, under 35 U.S.C. § 119(e), of U.S. Provisional Patent Application Ser. No. 60/647,662 filed Jan. 27, 2005 which is hereby incorporated by reference herein in its entirety.

### BACKGROUND OF THE INVENTION

The present disclosure relates to hospital bed accessories and more particularly to trapeze devices used by patients in hospital beds.

Trapeze devices connected to traction frames are known. These devices are generally attached to the traction frame with the trapeze device having a handle which hangs over the head of a patient at all times. When the patient needs to adjust position, the patient reaches up and pulls on the trapeze handle to lift their body or a portion of their body off of the sleep surface. The frame that the trapeze handle is connected to is typically fixed. The handle therefore stays in a fixed position. When the hospital bed articulates, the relative position of the handle to the patient changes.

### SUMMARY OF THE INVENTION

The present invention comprises one or more of the features recited in the appended claims and/or the following features which, alone or in any combination, may comprise patentable subject matter:

A trapeze apparatus for use on a patient-support device is provided. The apparatus may include a pivotable coupler having a centerline which defines a pivot axis. The pivotable coupler may be configured to attach to the patient-support device. The trapeze apparatus may include an arm having a first end coupled to the pivotable coupler and pivotable about the pivot axis. The arm may include multiple arm portions which are telescopically extensible relative to each other. One or more of the arm portions may be bent at a 90 degree angle, for example.

The trapeze apparatus may also include a patient interface unit pivotably coupled to the second end of the arm. When present, the patient interface unit may include a trapeze handle, patient input devices, lights, light switches, a handle, and/or a video display. The patient interface unit may also include a display that is a television. The display may be a liquid crystal display (LCD) and/or a touchscreen which allows patients to choose options from the display. The display may be menu driven and may be operable by input devices such as buttons, keyboards, computer mice, styli, or the like.

The patient input devices of the patient interface unit may include on/off buttons and/or touchscreen displays configured to control one or more functions of the patient-support device. The patient input devices may be configured to control patient environment apparatuses such as a television, a radio, room lighting, or heating and air conditioning. The patient input devices may be configured to operate a nurse call system or a two way communication system with caregivers at a remote location.

In some embodiments, the trapeze apparatus may include a motor, a tether windingly coupled at one end to the motor coupled at a second end to the patient interface unit. The tether may extend through each portion of the arm. The motor and tether may be configured such that rotation of the motor in one direction extends the tether and rotation of the motor in the opposite direction retracts the tether. The patient interface unit may include a trapeze handle. The trapeze handle may include two links or bars coupled to the tether and a cross-bar handle coupled to and positioned to extend between each of the links. Illustratively, the cross-bar handle may be gripped by the patient to allow the patient to adjust his or her position. The cross-bar handle may also be configured to function as a bed sheet gripper to grip a sheet under a patient and so that the sheet may be repositioned, and thereby the patient supported by the sheet may be repositioned. For example, the cross-bar handle may grip the sheet and rotate relative to the links to wind the sheet around the handle and may lock to prevent the sheet from unwinding. The cross-bar handle may also include a release mechanism to quickly release the sheet from the handle.

The trapeze apparatus may be configured to attach to the frame of the patient-support device at either the head end or the foot end of the frame. For example, the trapeze apparatus may be configured to attach to a head deck of the patient-support device. The arm may pivot between a position perpendicular to the head deck surface of the patient-support device and a position parallel to the head deck surface of the patient-support device. Furthermore, the arm may have a pivotable range of approximately 180 degrees about the pivot axis.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a trapeze apparatus of the present disclosure mounted to an articulating head section of a hospital bed;

FIG. 2 is a perspective view of a portion of the trapeze apparatus showing a patient interface unit of the trapeze apparatus;

FIG. 3 is a perspective view of another trapeze apparatus mounted to the head section the hospital bed showing the apparatus lifting a sheet under a patient to rotate the patient;

FIG. 4 is a side view of the trapeze apparatus and the hospital bed of FIG. 3;

FIG. 5 is a top view of the trapeze apparatus of FIG. 3 trapeze apparatus pivoted to a position parallel to a horizontal patient-support surface of the hospital bed to engage and grip the sheet under the patient to transfer a patient from the bed to a transport apparatus adjacent the bed; and

FIG. 6 is a perspective view similar to FIG. 5 showing the trapeze apparatus having completed the transfer of the patient from the hospital bed to the transport apparatus.

### DETAILED DESCRIPTION OF THE DRAWINGS

A trapeze apparatus 12 for use with a patient-support device, such as a hospital bed 10, for example, is shown in FIG. 1. The trapeze apparatus 12 includes a pivotable coupler 14 illustratively coupled to a head deck section 32 of the bed 10, an arm 16 coupled at a first end to the coupler 14, and a patient interface unit 18 coupled to a second end of the arm 16. In use, the trapeze apparatus 12 includes a cross-bar handle 54 to be gripped by a patient 44 to allow the patient 44 to pull himself up in order to adjust his position in the hospital bed 10. In another embodiment, a trapeze apparatus 112 shown in FIGS. 3-6, the cross-bar handle 54 of the patient interface unit 18 may rotate relative to two arms 46 to engage a bed sheet of hospital bed 10 such that the trapeze apparatus 12 serves as a powered patient assistance and transfer device. For example, the trapeze apparatus 112 may be used to transfer the patient 44 from the hospital bed to a transport apparatus 80, as shown in FIGS. 5 and 6.

Looking now to FIG. 1, the arm 16 includes a first arm portion 20, a second arm portion 22, and a third arm portion 24 telescopically coupled to each other. Illustratively, the first arm portion 20 is a tube having a square-shaped cross-section and the second arm portion 22 is another tube having a square-shaped cross-section. The second arm portion 22 has external dimensions that are smaller than the internal dimensions of the first arm portion 20 allowing the second arm portion 22 to be received within the first arm portion 20 to telescopically extend from the first arm portion 20 in order to change the location of the patient interface unit 18 for example. In a similar manner, the third arm portion 24 is a tube with a square cross-section, the external dimensions of which are slightly smaller than the internal dimensions of the second arm portion 22. This allows the third arm portion 24 to extend telescopically from the second arm portion 22. It should be understood, however, that the first arm portion 20 may be received within the second arm portion 22. Similarly, the second arm portion 22 may be received within the third arm portion 24. Furthermore, the arm portions 20, 22, 24 may have other cross-sectional shapes such as circular or triangular cross-sectional shapes, for example.

The second arm portion 22 includes a bend near the center of a length of the second arm portion 22. In the illustrative embodiment of FIG. 1, the bend is approximately 90 degrees. In other embodiments, the bend may be at an acute angle or an obtuse angle depending on the configuration of the patient-support device 10 to which the trapeze apparatus 12 is coupled. Further, the illustrative arm 16 includes three arm portions; however, the arm 16 may include any number of arm portions. The arm portions 20, 22, 24 are made of metal. However, the arm portions 20, 22, 24 may be constructed of plastic, composite, wood, or any other suitable material having sufficient strength to support the load placed on the arm portions 20, 22, 24.

As shown in FIG. 1, the pivotable coupler 14 includes a pivot rod 26 coupled to a mounting bracket 30, and a pivot collar 28 retained on the pivot rod 26 and free to rotate about the pivot rod 26. Illustratively, the mounting bracket 30 is coupled to the head deck section of the patient-support device 10. The arm 16 is attached to the pivot collar 28 and the pivot rod 26 defines a pivot axis 82 about which the arm 16 and collar 28 pivot. As such, rotation of the pivot collar 28 and arm 16 about the pivot rod 26 results in movement of the patient interface unit 18 relative to patient 44. The pivot collar 28 and pivot rod 26 are configured so that the pivot collar 28 has an internal bearing surface and the pivot rod 26 has an external bearing surface to facilitate free rotation.

In the illustrative embodiments, the pivot collar 28 is made of metal and the first arm portion 20 of the arm 16 is welded thereto. However, the pivot collar 28 may also be made of plastic, composite, wood, or any other suitable material. Further, the first arm portion 20 of the arm 16 may be integrally formed with the pivot collar 28 in the manufacturing process (e.g. casting or injection molding).

In some embodiments, the pivot collar 28 may include a locking mechanism (not shown) which locks the rotation of the pivot collar 28 relative to the pivot rod 26. In some embodiments, the locking mechanism may be biased to a locked position requiring the locking mechanism to be released to allow the pivot collar 28 to rotate on the pivot rod 26. In other embodiments, the pivot collar 28 may include a threaded hole (not shown) and a threaded rod (not shown) received in the threaded hole such that the threaded rod is able to be tightened against the pivot rod 26 to prevent rotation of the pivot collar 28. In still other embodiments, the pivot collar 28 may include a wrap spring lock (not shown) which grips the pivot rod 26 to prevent rotation of the pivot rod 26 until released to then allow rotation of the pivot rod 26. In some embodiments, the locking mechanism may include detents, notches, teeth, or some other mechanism to lock the pivot collar 28 in a finite number of positions about the pivot rod 26. In some other embodiments, the locking mechanism may lock the pivot collar 28 in an infinite number of positions about the pivot rod 26.

Illustratively, the mounting bracket 30 is attached to a head deck 32 of the patient-support device 10. The head deck 32 is one of several articulating deck sections which support a mattress 34 on the patient-support device 10. Other deck sections include a seat deck 38, a thigh deck 40, and a foot deck 42. The deck members 32, 38, 40, 42 are all supported on a frame 36 of the patient-support device 10. A patient 44 is supported on the mattress 34. Articulation of the deck members 32, 38, 40, 42 provides multiple positions for the patient 44 who is reclining on the patient-support device 10. When the head deck 32 is articulated from a flat position to the inclined position shown in FIG. 1, the trapeze apparatus 12 maintains the relative relationship to the patient 44. In other words, by being coupled to the head deck 32 of the hospital bed 10, the trapeze apparatus 12 moves with the head deck 32 as the head deck 32 is articulated for the comfort of the patient 44 between an upright and a generally flat or horizontal position thus maintaining the relative position of the patient interface unit 18 and the patient 44.

The trapeze apparatus 12 may also be mounted directly to the frame 36 of the patient-support device 10 and may be mounted to the frame 36 at the head end of the patient-support device 10. Alternatively, the trapeze apparatus 12 may be mounted to the frame 36 at the foot end of the patient-support device 10. Further, the trapeze apparatus 12 may be mounted to a side portion of the frame of the patient-support device 10. Although an articulating hospital bed 10 is shown, the trapeze apparatus 12 may be coupled to a non-articulating hospital bed or another patient support apparatus such as a stretcher, wheelchair, or gurney, for example.

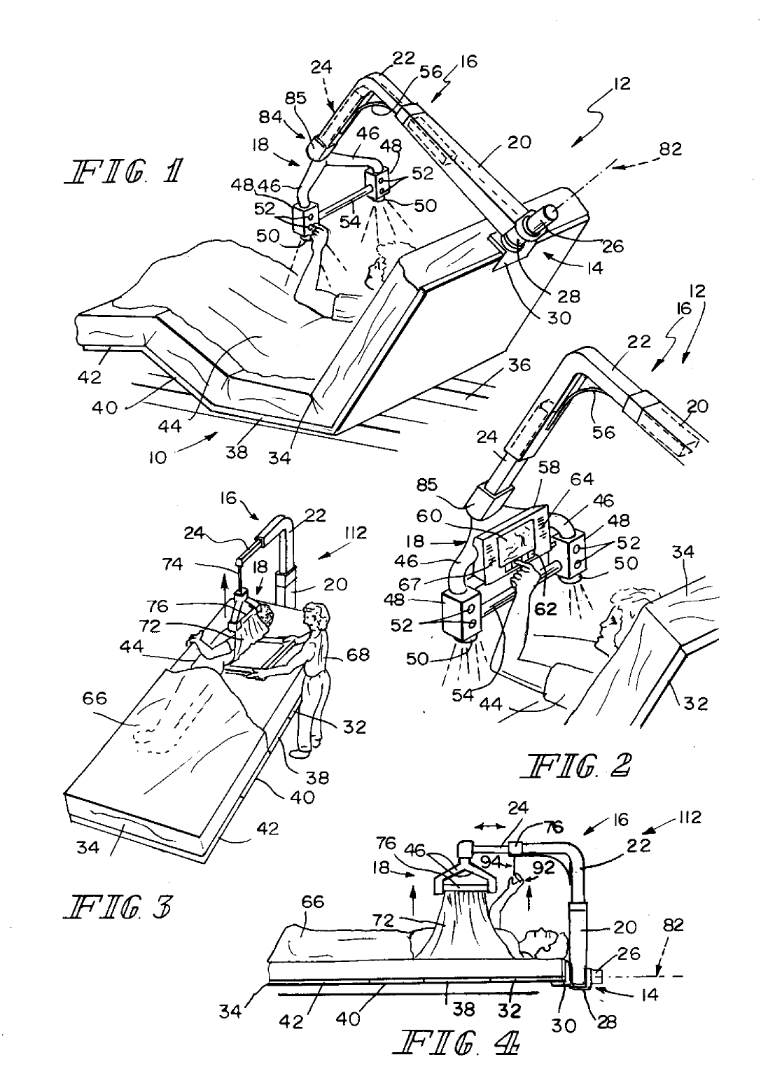

As mentioned above, the patient interface unit 18 is coupled to the second end of the arm 16, and more particularly to the second end of the third arm portion 24 in order to place the patient interface unit 18 in an accessible position above the patient 44 as shown in FIGS. 1 and 2, for example. The patient interface unit 18 provides the patient 44 access to various controls and accessories. The illustrative patient interface unit 18 shown in FIGS. 1 and 2 includes two links or bars 46 coupled at a first end to the third arm portion 24 to form a generally “y-shaped” yoke and a control box 48 coupled to a second end of each link 46. Each control box 48 illustratively includes two lights 50 and four input devices 52 for controlling various bed and/or environment functions as described in more detail below. The cross-bar handle 54 of the patient interface unit 18 is positioned between and fixed to each of the control boxes 48 and the combination of the links or bars 48 and the cross-bar handle 54 form a triangular trapeze handle. The patient 44 may grip the cross-bar handle 54 to lift and reposition himself on the patient-support device 10. In some embodiments, the cross-bar handle 54 may include a covering (not shown) which facilitates gripping of the cross-bar handle 54 by the patient 44. This covering may be rubber, foam, plastic, or similar material that has a high coefficient of friction and provides a comfortable grip for the patient.

The patient interface unit 18 is coupled to the arm 16 by a ball-and-socket connector 84 coupled to the second end of arm 16. The ball-and-socket connector 84 includes a socket 85 coupled to the arm 16. The socket 85 is configured to retain a ball (not shown) for rotation of the ball within the socket in a number of directions. The patient interface unit 18 is coupled to the ball (not shown) such that the patient interface unit 18 is free to move with the ball of the ball-and-socket connector 84 in a number of directions. As the trapeze apparatus 12 is pivoted about axis 82, the patient interface unit 18 remains generally horizontal to the patient. Maintaining the horizontal orientation improves the usability of the patient interface unit 18 for the patient 44 when the location of the patient interface unit 18 is off-center relative to the patient-support device 10.

The trapeze apparatus 12 may further include an electrical cord (not shown) for supplying electrical power to the control boxes 48. The cord is routed through the arm 16 and is attached to the arm portions 20, 22, 24 in a manner which allows the cord to extend and retract as the arm portions 22 and 24 extend and retract. In some embodiments, the cord is routed through the arm 16. The cord is connected to the electrical power supply of the patient-support device 10. In some embodiments, the cord may be routed directly to a wall outlet. In some embodiments, a second cord is routed alongside the first cord of the illustrative embodiment. One of the cords may be dedicated to providing power to the control boxes 48 with the other providing signals from the input devices 52 to control various bed and/or environment functions.

The control boxes 48 provide an electrical junction point for the input devices 52. The input devices 52, which are illustratively push-buttons, as shown in FIGS. 1 and 2, are configured to allow the patient 44 to input signals which may result in articulation of the patient-support device 10 and/or adjustments made to various devices in the patient environment. For example, the input devices 52 may control the height of patient-support device 10 or may alter articulation functions of patient-support device 10 such as head elevation or knee elevation, or may control various other patient controlled devices such as television channel up, channel down, volume up, volume down, radio, audio, direct lighting, or indirect lighting. The input devices 52 may be configured to activate or operate a nurse call system. Illustratively, the input devices 52 also control the lights 50 coupled to the control boxes 48. Illustratively, the input devices 52 receive and transmit signals through the electrical cord, however, it should be understood that the input devices may use wireless signals such as infra red signals or radio frequency signals to signal activation of the various bed and/or environment functions.

Looking now to FIG. 2, the patient interface unit 18 is shown to include a video terminal 58 coupled to and positioned between the two links 46. The video terminal 58 includes a display 60, multiple buttons 62, and speakers 64. Video terminal 58 may be connected to devices external to the patient-support device 10 through the cord. Illustratively, the video terminal 58 functions as a television display. The speakers 64 provide audio from the television, a radio, or from a caregiver station remote to the patient room. The buttons 62 are used by the patient 44 as input devices similar to those described previously. For example, the buttons 62 may be used to change the television channel, audio volume, or control various devices in the patient environment. In some embodiments, the buttons 62 are omitted and the display 60 functions as a touchscreen display with various inputs displayed and operable from the touchscreen. The functionality of the display may include the functionality of the touchscreen display pendant as disclosed in U.S. Provisional Patent Application Ser. No. 60/608,979 which was filed Sep. 10, 2004 and which is hereby incorporated herein by reference.

As mentioned above, the trapeze apparatus 12 may also aide a caregiver in rolling or turning the patient to one side. As shown in FIG. 3, therefore, a trapeze apparatus 112 includes a tether 74 connected at a first end to the patient interface unit 18. The tether 74 is positioned within the arm 16 such that a second end of the tether 74 is connected to a motor (not shown) of the trapeze apparatus 112. The trapeze apparatus 112 is similar to apparatus 12 and as such, like reference numerals have been used to represent like components. In this embodiment, the ball-and-socket connector 84 shown in FIG. 1 with respect to the apparatus 12 is omitted and the patient interface unit 18 is supported by the tether 74. The motor (not shown) is winds the tether 74 when rotating in one direction and unwinds the tether 74 when rotating in the opposite direction. The motor may be located at the base of the arm 16 or may be coupled to the frame of the patient-support device 10.

In the illustrative embodiment of FIG. 3, the cross-bar handle 54 is a sheet gripping roller 76 as disclosed in U.S. Provisional Patent Application Ser. No. 60/389,212 which was filed Jun. 17, 2002 and which is hereby incorporated herein by reference. As shown in FIG. 3, a lift sheet 72 has been placed under the shoulders of the patient 44 and connected to the sheet gripping roller 76 of the trapeze apparatus 112. In use, the tether 74 may then be retracted slightly to partially lift the lift sheet 72 and thus partially lift the shoulders of the patient 44 off of the mattress 34. Illustratively as shown in FIG. 3, a caregiver 68 may then place an x-ray cassette 70 under the shoulders of the patient 44. In the illustrative trapeze apparatus 112 shown in FIG. 3, the patient interface unit 18 is not coupled directly to the arm 16, but is coupled to the tether 74 which passes through the arm 16. The sheet gripping roller 76 is lockable to prevent rotation so that the roller may function as a handle.

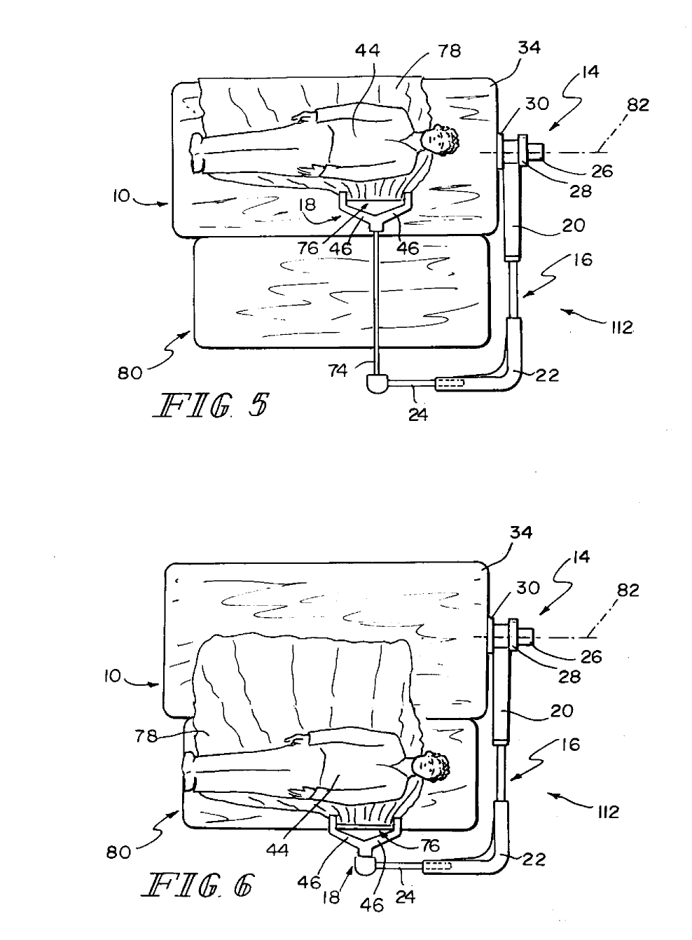

Looking now to FIG. 4, another trapeze apparatus 112 where the patient interface unit 18 includes the sheet gripping roller 76. The patient interface unit 18 is connected to arm 16 through the ball-and-socket connector 84. In this illustrative embodiment of trapeze apparatus 112 shown in FIGS. 4-6, a second arm portion 222 and third arm portion 224 are powered to perform telescopic extension and retraction. The arm portions 222, 224 are powered by a linear actuation device such as an electromechanical actuator, hydraulic cylinder, or pneumatic cylinder. FIG. 4 shows the arm 16 in the process of lifting the patient 44 with the lift sheet 72 engaged with the sheet gripping roller 76. Another handle 92 is coupled to the arm by a tether 94 to hang above the patient 44 such that the patient may grip the handle 92 to position himself. Specifically, the tether 94 connected to a collar 96 coupled to the second end of second arm portion 222. It should be understood that some embodiments include the powered telescopic arm portions 222, 224 and/or the tether 74 or any combination thereof.

In addition to gripping a lift sheet 72, the sheet gripping roller 76 of apparatus 112 may be used to assist a caregiver in transporting a patient from one support apparatus to another as shown, for example in FIGS. 5 and 6. In order to transport he patient 44, the trapeze apparatus 112 is pivoted about axis 82 to position the arm 16 of the apparatus 112 to lie in a plane generally parallel to an upper surface of mattress 34 when the deck members 32, 38, 40 and 42 are in a flat or horizontal configuration. In use, each of the trapeze apparatuses 12 (shown in FIGS. 1 and 2), 112 (shown in FIGS. 3, 5 and 6), and 212 (shown in FIG. 4) are able to be moved between a first position over the patient, as shown in FIGS. 1-4, and a second position beside the patient, as shown in FIGS. 5 and 6. Illustratively, in the first position, the first arm portion 20 of the arm 16 extends vertically from the mattress 34. As shown in FIG. 1, for example, the first arm portion 20 is generally perpendicular to the head deck section 32 (or a plane running through the head deck section 32) of the patient-support device 10. The 90 degree bend in the second arm portion 22 positions the patient interface unit 18 in front of and above the patient to allow the patient access to the controls of the patient interface. In the second position, shown in FIGS. 5 and 6, however, the arm 16 of the apparatus 112 has been pivoted about the pivot axis 82 such that the first arm portion 20 is generally parallel to the head deck section of the bed. In this position, the trapeze apparatus 112 (as well as trapeze apparatus 12) can be used to perform patient transfers.

For example, a transport apparatus 80 is placed next to the patient-support device 10 as is shown in FIG. 5. The patient is positioned on a transfer sheet 78 which has been engaged with the sheet gripping roller 76 of the trapeze apparatus 112. The tether 74 is in an extended position in FIG. 5. As the tether 74 is retracted by the motor (not shown), the patient 44 and transfer sheet 78 are pulled across the upper surface of the mattress 34 onto the transport apparatus 80. FIG. 6 shows the patient in the transferred position. A similar process can be performed with the powered telescoping of the arm portions 22, 24 providing the lateral motion necessary to perform the transfer of the patient 44 from the patient-support device 10 to the transport apparatus 80. While the arm 16 has been pivoted to one side of the patient-support device 10 in FIGS. 5-6, it should be understood that the arm 16 may be pivoted to the opposite side and operate in a similar manner to that shown in FIGS. 5-6 to transfer the patient back onto the patient-support device 10 from the transport apparatus 80.

Although certain illustrative embodiments have been described in detail above, variations and modifications exist within the scope and spirit of this disclosure as described and as defined in the following claims.

1. An apparatus for use with a patient-support device, the apparatus comprising
a support structure coupleable to the patient-support device,
a trapeze bar coupled to the support structure, the trapeze bar having a substantially horizontal grip portion that is grippable by a patient supported by the patient-support device, and
a patient interface unit including at least one user input to activate a function of the patient-support device, the patient interface unit coupled to the trapeze bar.

2. The apparatus of claim 1, wherein the support structure comprises a pivotable coupler having a pivot axis and configured to be coupled to the patient-support device, and an arm having a first end coupled to the pivotable coupler, the arm being pivotable about the pivot axis.

3. The apparatus of claim 2, wherein the pivotable coupler includes a mounting bracket configured to be coupled to the patient-support device, a pivot rod coupled to the mounting bracket and formed to define the pivot axis, and a collar rotatable about the pivot rod and coupled to the first end of the arm.

4. The apparatus of claim 2, wherein the arm pivots between a first position generally perpendicular to a support surface of the patient-support device and a second position generally parallel to the support surface of the patient-support device.

5. The apparatus of claim 2, further including a locking mechanism coupled to pivotable coupler 14 to prevent rotation of the collar relative to the pivot rod.

6. The apparatus of claim 2, wherein the arm includes a first arm portion coupled to the pivotable coupler and a second arm portion telescopically coupled to the first arm portion.

7. The apparatus of claim 6, wherein one of the arm portions includes a bend.

8. The apparatus of claim 1, wherein the patient interface unit includes a housing and the user input is coupled to the housing.

9. The apparatus of claim 8, further comprising a light and the at least one user input being operable to control the light.

10. The apparatus of claim 1, wherein the patient interface unit includes a display.

11. The apparatus of claim 10, wherein the display comprises a touchscreen.

12. The apparatus of claim 1, wherein the patient interface unit comprises a nurse call input device.

13. A trapeze apparatus for use with a patient-support device, the apparatus comprising
a pivotable coupler having a pivot axis and configured to be coupled to the patient-support device,
an arm having a first end coupled to the pivotable coupler, the arm being pivotable about the pivot axis,
a tether extending through at least a portion of the arm, and
a patient interface unit including two links pivotably coupled to the tether at a second end of the tether a handle bar extending between the links, and a patient activated control to activate at least one function of the patient support device.

14. The trapeze apparatus of claim 13, wherein the pivotable coupler includes a mounting bracket configured to be coupled to a structure of the patient-support device, a pivot rod coupled to the mounting bracket and formed to define the pivot axis and a collar rotatable about the pivot rod and coupled to the arm.

15. The trapeze apparatus of claim 14, wherein the arm pivots between a first position generally perpendicular to a support surface of the patient-support device and a second position generally parallel to the support surface of the patient-support device.

16. The trapeze apparatus of claim 13, wherein the arm includes a first arm portion coupled to the pivotable coupler and a second arm portion telescopically coupled to the first arm portion.

17. The trapeze apparatus of claim 16, wherein the second arm portion is powered to telescope relative to the first arm portion.

18. The trapeze apparatus of claim 13, wherein the patient interface unit includes a display.

19. The trapeze apparatus of claim 13, wherein the tether extends and retracts relative to the arm.

20. A trapeze apparatus for use with a patient-support device, the apparatus comprising
a pivotable coupler having a pivot axis and configured to be coupled to the patient-support device,
an arm having a first arm portion coupled to the pivotable coupler, a second arm portion telescopically coupled to the first arm portion, the second arm portion having a bend, and a third arm portion telescopically coupled to a second end of the second arm portion, the arm being pivotable about the pivot axis, and
a patient interface unit coupled to the arm, the patient interface unit including a sheet gripping roller and patient activated controls.
